(19) United States
(12) Patent Application Publication
(10) Pub. No.: US 2023/0292791 A1
(43) Pub. Date: Sep. 21, 2023

(54) FEED SUPPLEMENT AND EXTRACT

(71) Applicant: Simon Robinson, Kaiapoi (NZ)

(72) Inventor: Simon Robinson, Kaiapoi (NZ)

(21) Appl. No.: 18/021,253

(22) PCT Filed: Aug. 25, 2021
(86) PCT No.: PCT/IB2021/057773

§ 371 Date: Feb. 14, 2023

(30) Foreign Application Priority Data
Sep. 4, 2020 (NZ) 767693

(51) Int. Cl. A23K 10/30; A23K 30/12; A23K 50/10

(52) U.S. Cl. CPC A23K 10/30; A23K 30/12; A23K 50/10

(57) ABSTRACT

A method of making a product from grass that includes carrying out steps A to D in order, where: Step A is cutting the grass to a length of between 35 mm to 150 mm resulting in cut grass with at least 90% leaf and little to no dead plant material; Step B is drying of the cut grass to produce dry grass; Step C is collecting and transferring the dry grass to at least one first container, removing excess air and then sealing the at least one first container; and Step D is aging the dry grass in the at least one first containers in a cool dark place for a primary period of time to produce a dry product.

### TECHNICAL FIELD

The present invention relates to a feed supplement and aqueous extract made from harvested grass.

### BACKGROUND ART

It is common for grass, foliage and various green fodder to be harvested and converted to silage, baleage and hay.

Silage is grass or green fodder that is harvested and processed without any intervening drying. Silage is produced when beneficial bacteria anaerobically ferment some of the sugars in grass to lactic acid. This anaerobic fermentation of the grass and green fodder minimises the growth of spoilage micro-organisms which has been found to preserve nutrients. However, lactic acid fermentation only starts once there is no air left so the grass and green fodder harvested is transferred to anaerobic conditions without any intervening drying. To preserve the protein and minimise the yeast growth a quick drop in pH of the ensiled material to below pH 5 is needed, this requires the harvested grass and green fodder is moved to an anaerobic (low air/oxygen) environment as soon as practical.

To quickly move the harvested material to an anaerobic environment it is normally compacted to reduce interstices to a minimum. To successfully compact quickly the chop length is normally in the range of 15 mm to 25 mm, though if the dry matter is between 25% and 30% it is normally recommended to be between 25 mm and 50 mm. The British Grasslands Society recommends a chop length of 10 mm to 25 mm for grass with >20% dry matter and 20 mm to 40 mm for grass with <20% dry matter as they have found increased spoilage losses outside these ranges.

The optimum pH for sileage is 3.5 to 4.5 which prevents undesirable microorganism growth, though some green fodder may be close to pH 5. Full fermentation of silage normally takes 14 to 30 days. To increase the speed of silage formation inoculation with lactic acid bacteria has been used.

Baleage is prepared in a similar manner to silage, however the grass or green fodder is allowed to wilt, partially dry, before it is sealed in an airtight environment to anaerobically ferment. The lower moisture content of baleage (baled silage) compared to silage can slow the fermentation resulting in less complete fermentation and a pH in the range of 4.5 to 5 is often the result. Full fermentation of baleage normally takes 42 to 56 days, though it can take longer than this, and some studies have shown a reduced digestibility due to wilting.

Hay is grass and other foliage that has been harvested and dried for use as fodder. It is dried longer than baleage and is surrounded by air so it has not undergone anaerobic fermentation. It is then stored in a dry shed.

Silage and baleage depend on the formation of lactic acid and a low pH to prevent spoilage and hay requires drying to a low moisture content.

Homemade silage using fresh cut grass is known. The grass is cut, and the air removed. Unfortunately, trials have shown that the grass turns to a mush and limited storage success has been achieved.

There are many areas of grass that are mown on a regular basis where the grass is presently discarded or sometimes collected and composted. For example, small farms life style properties, Council parks, sports field, recreation areas, roadside berms, private sports areas such as golf courses and the like.

Any discussion of the prior art throughout the specification is not an admission that such prior art is widely known or forms part of the common general knowledge in the field.

The present invention provides a method of using cut grass, and potentially other green fodder to produce a feed supplement and/or aqueous extract or other products that provide the consumer with a useful choice.

### DISCLOSURE OF INVENTION

The present invention provides a method of making a product from grass that includes carrying out steps A to D in order, where:
Step A is cutting the grass to a length of between 35 mm to 150 mm resulting in cut grass with at least 90% leaf and little to no dead plant material;
Step B is drying of the cut grass to produce dry grass;
Step C is collecting and transferring the dry grass to at least one first container, removing excess air and then sealing the at least one first container; and
Step D is aging the dry grass in the at least one first containers in a cool dark place for a primary period of time to produce a dry product.

Preferably the leaf content of the cut grass is no less than 95%. In a highly preferred form the blade content is greater than 98% or greater than 99%.

Preferably there is no observable dead plant material present in the cut grass (less than 1%, preferably less than 0.5% or 0.1%).

Preferably the drying in step B is carried out until the cut grass, when squeezed in a hand leaves the hand dry with the grass leaf not crumbling or breaking.

Preferably the at least one first container is a black plastic bag with a volume of between 50 litres and 150 litres. Preferably the plastic bag is a polythene bag with a drawstring.

Preferably the primary period in step D up to 6 months. In a highly preferred form the primary period does not exceed 8 weeks. In a highly preferred form the primary period in step D is between 3 and 4 weeks.

Preferably the temperature in step D does not exceed 35° C. In a highly preferred form the temperature in step D does not exceed 30° C. In a still further more highly preferred form the temperature in step D does not exceed 25° C. In a still more preferred for the temperature in step D does not exceed 20° C.

Preferably the dry product is further processed to create a feed supplement. Preferably this further processing is simply re-packaging the dry product.

Preferably the dry product has a pH between 5 and 6. In a highly preferred form the pH of the dry product is between 5.4 and 6.

Preferably a liquid extract is made from the dry product by carrying out steps E to H in order, where steps E to H are:
Step E is transferring a portion of dry product to a second container and adding a liquid solvent until the dry product is covered;
Step F is steeping the dry product in the liquid solvent for a secondary period to create a solvent extract;
Step G is transferring the solvent extract to at least one third container whilst filtering the solvent extract to remove particulate material then sealing the at least one third container ensuring minimal ullage;
Step H is aging the solvent extract in the at least one sealed third container for a tertiary period to form a liquid extract.

Preferably the solvent is an aqueous solvent. In a highly Preferred form the solvent is water. Preferably in step E maximum surface contact between the dry product and the liquid solvent is ensured. Preferably this maximum surface contact is achieved by agitating or moving the dry product to minimise any interstitial gas pockets or voids.

Preferably the second container is an open container.

Preferably the secondary period is between 4 and 12 hours. In a more preferred form the secondary period is between 4 and 8 hours.

Preferably the tertiary period is at least 3 weeks. Preferably the tertiary period is less than 6 months. In a more preferred form the tertiary period is less than 8 weeks. In a still more preferred form the tertiary period is no more than 6 weeks. In a highly preferred for the tertiary period is 3 to 4 weeks. Preferably the tertiary period is determined by a storage temperature, where the storage temperature is the temperature at which the solvent extract is stored. Preferably the tertiary period increases as the storage temperature decreases.

In an alternative preferred form step E is at least 3 weeks and the pH of the liquid extract is less than pH 6. In a more preferred form the liquid extract has a pH of no more than 5. In a highly preferred form the pH of the liquid extract is no more than 4.5. In a still more highly preferred form the pH of the liquid extract is no more than 4.3.

In a further highly preferred form the solvent extract starts as a clear black liquid and this changes to the liquid extract which is a reddish brown liquid and the tertiary period is determined by this change. In a highly preferred form the tertiary period is the time it takes for this colour change to occur.

Preferably minimal ullage means that the void above a liquid level of the solvent extract in the at least one third container is no more than 5% he height of the third container. In a highly preferred form the void above the liquid level of the solvent extract in the at least one third container is no more than 1% the height of the third container. Preferably the minimal ullage is created by overflowing the at least one third container before sealing.

Preferably the at least one third containers are stored in a cool (less than 30° C.) dark place.

Preferably the at least one third containers are plastic bottles. In a preferred form the plastic bottles are PET (Polyethylene terephthalate) bottles. Preferably the PET bottles are between 1 litre and 2.25 litres in volume.

The present invent also provides a feed supplement produced by the method.

The present invention also provides a liquid extract produced by the method.

The present invention also provides a liquid product formed from the liquid extract.

The present invention also provides a metabolite and/or chemical species extract formed from the liquid extract, liquid product or ‘bug’ concentrate.

Preferably the metabolite and/or chemical species extract is in a dried or concentrated form. Preferably the concentrated form is liquid, possibly a high or very high viscosity liquid.

Preferably the dried or concentrated form of the metabolite and/or chemical species extract is created by known means. Preferably the known means includes reverse osmosis, precipitation, spray drying, vacuum drying, thermal drying, crystallisation, evaporation (vacuum or thermal), cooling/freezing, solvent extraction (including stationary solid phase), formation of insoluble species, electrophoresis, or a combination of two or more of these sequentially or simultaneously.

### BRIEF DESCRIPTION OF DRAWINGS

By way of example only, a preferred embodiment of the present invention is described in detail below with reference to the accompanying drawings, in which:

FIG. 1 is a flowchart of the method;

### BEST MODE FOR CARRYING OUT THE INVENTION

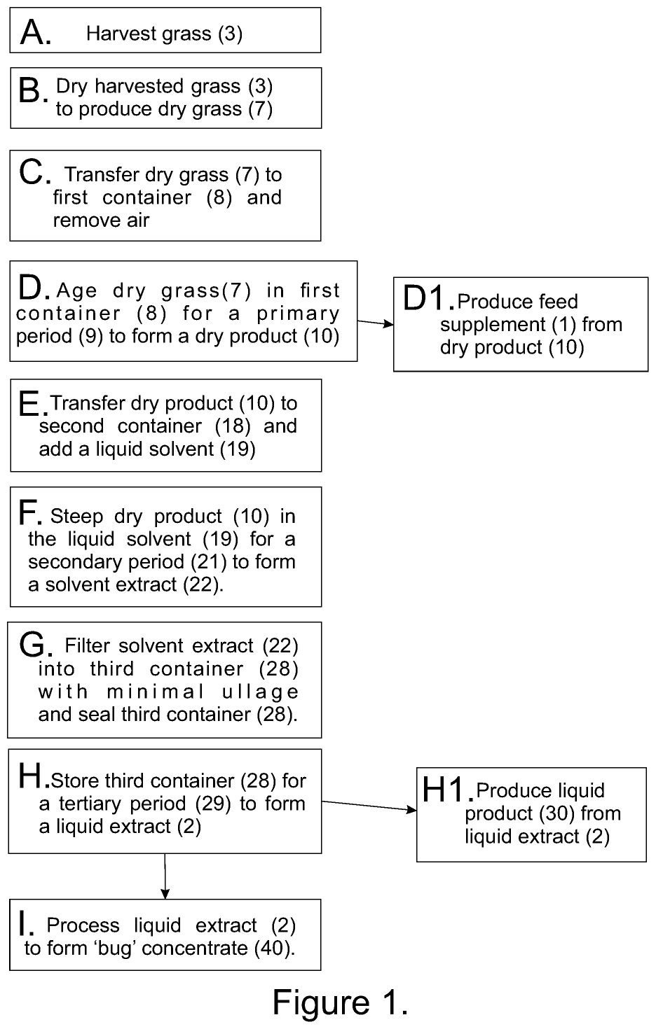

Referring to FIG. 1 a preferred method of preparing a feed supplement (1) and liquid extract (2) from cut grass (3) will be described. The method includes steps A to H where certain steps, E to H, are optional and only required to prepare the liquid extract (2). Further processing of the liquid extract (2) can be undertaken to produce a ‘bug’ concentrate (40).

The steps are undertaken as follows:
A. Harvest the grass (3);
B. Process the harvested grass (3) by drying to form dry grass (7);
C. Transfer the dry grass (7) to one or more first container (8) and remove the air;
D. Age the dry grass (7) for a primary period (9) to form a dry product (10);
If a feed supplement (12) is the required output then step D1 is undertaken.
D1. Produce feed supplement (12) from dry product (10).
If a liquid product (14) is required then steps E to H1 are undertaken in order, where steps E to H are:
E. Transfer dry product (10) to one or more second container (18) and add a liquid solvent (19);
F. Steep dry product (10) in the liquid solvent (19) for a secondary period (21) to form a solvent extract (22);
G. Filter solvent extract (19) into third container (28) with minimal ullage and seal third container (28);
H. Store third container (28) for a tertiary period (29) to form a liquid extract (2);
Step H is followed by step H1 if a liquid product (30) is required, where step H1 is:
H1 Produce liquid product (30) from liquid extract (2).
If a ‘bug’ concentrate (40) is required then step I is undertaken, where step I is:
I. Process liquid extract (2) to form ‘bug’ concentrate (40).

Each of the steps will now be described in more detail:

In step A the grass (3) is cut to a length of between 35 mm and 150 mm, ensuring that the leaf content is at least 90% with little or no dead or dry material present. Preferably the leaf content is at least 95% with no observable dead material present. To get this high level of leaf material with essentially no dead material present in the cut grass (3) the grass (3) may need to be cut then allowed to regrow, with this cutting and regrowing undertaken a number of times to achieve the required leaf and dead material content. This cutting and regrowing cycle to achieve the required leaf content is not considered economical to undertake for silage or baleage production. Step A is only undertaken once any dew or surface moisture droplets has gone.

If cutting and regrowing is not feasible then success has been achieved by raising the mowing height to avoid the inclusion of any observable dead material being collected with the grass (3).

In step B the cut grass (3) is evenly spread out on the ground then allowed to dry in sunlight until compressing the leaf results in essentially no liquid release but the material does not crumble (the leaf retains some resilience) forming dry grass (7). This state will vary depending on the type of grass (3). At present this drying to create dry grass (7) is achieved by simply allowing the cut grass (3) to remain on the ground in direct sunlight from 30 min to 48 hours, though normally 30 minutes to 2 hours is sufficient. The sunlight is felt to be important, however it is uncertain what level of cloud cover can be tolerated to achieve optimum results.

Please note that the term grass (3) is intended to include harvested material containing a certain amount of clover and/or lucerne.

The drying of the cut grass (3) to form dry grass (7) may possibly be accomplished by collecting the cut grass (3) and drying it without using direct sunlight, however trials to date have not been particularly successful. Alternative means of drying that may be successful include, passing moving air (cold/warm/hot) through or over the grass (3), spreading the grass (3) out on a surface and allowing open air drying (inside a structure or in the open) or a combination of these. This drying step creates dry grass (7) ready for step C.

In step C the dry grass (7) is collected and transferred to one or more first containers (8) and the air is removed. At present the dry grass (7) is collected ensuring little or no dead material is present in the dry grass (7), preferably there is no observable dead material present. Successful dry product (10) has been created with dry grass (7) with a length of between 10 mm and 120 mm. This dry grass (7) is then transferred to one or more first containers (8) which are polyethylene bags such as those purchased as rubbish bags for kitchen or gardening use and the contents compressed to remove as much air as practical before the bag is sealed by tying off. This process will leave some air in the first container (8) and allows for expansion without the seal being broken. There may be some advantage in flushing the contents with nitrogen before sealing or using a vacuum pump to reduce the air volume even further. It should also be noted that the bags may have minor perforations or holes that allow some atmospheric ingress, this does not appear to cause any problems though it may reduce the quality, this is simply not known. It should be noted that in most cases the dry grass (7) has been ‘double bagged’, that is put inside a first bag which is then placed inside a second bag (the first and second bags becoming the first container (8)), the first bag can be compressed then tied off before being placed in the second bag and the air between the two bags being minimised before the second bag is tied off, or simply one bag being placed inside the other, the air removed and the inner then the outer bag tied off.

The first containers (8) used to date have all been commercially available black plastic (most likely polyethylene) bags from 20 litres to 120 litres in size. It is uncertain if the size, colour, composition and/or thickness of the plastic bag is important. For example, polythene bags have a certain gas permeability that varies depending on composition and thickness. It is believed that the use of black plastic bags rather than clear plastic bags is important, but, this has not been confirmed.

It has been found that tightly compacting the contents of the first containers (8) to remove as much air as possible (using a lever for mechanical advantage) gives a much better result. This is felt to be an important step, but it is felt that similar results can be achieved by gas flushing the first containers (8) to remove much or all of the oxygen/air (CO₂, N₂ or other gas flushing).

In step D the dry grass (7) in the one or more first containers (8) is aged in a cool, less than 30° C. and preferably below 25° C., dark place for between 3 and 4 weeks. Aging can be up to 9 months, however, it is felt there is an activity drop off if aging is longer than 6 months. During this aging period the dry grass (7) is transformed into a dry product (10) with a sweet smell, without the pH dropping below about pH 5.5 (pH is measured the same way as silage by the addition of a certain amount of water to the material and the pH of the liquid taken). This dry product (10) can undergo further processing (Step D1) or simply be used directly as a feed supplement (12).

In step D1 (when undertaken) the dry product (10) is further processed to produce the feed supplement (12), this processing can include packaging, blending with other fodder and/or blending with mineral supplements. In many cases the dry product (10) is used as the feed supplement (12) directly.

In optional step E the dry product (10) is loosely packed into second containers (18) which are open containers, and a liquid solvent (19) is added until it covers the dry product (10). The dry product (10) is agitated to dislodge any pockets of air filling interstitial voids with liquid solvent (10) improving the contact between the liquid solvent (19) and the surface of the dry product (10). In most cases the liquid solvent (19) will be water or an aqueous solution, however other liquid solvents may be able to be used. Liquid solvents containing water with some alcohols (methanol/ethanol) or other water soluble/miscible liquids, or even a non-aqueous solvent may prove to offer additional advantages as may dissolving salts or other species in the solvent. It has been found that putting a lid on the container can result in undesirable bacterial/microbial activity, thus it appears that the atmosphere above the liquid solvent (10) may affect this liquid extraction phase.

In step F, which forms part of the optional liquid extract (2) formation phase, the liquid solvent (19) is left in contact with the dry product (10) for between 4 and 12 hours to form the solvent extract (22). This contact time, the secondary period (21), is preferably 6 to 8 hours. It is uncertain if agitation of the dry product (10)/liquid solvent (19) mixture could reduce this secondary period (21). The solvent extract (22) is effervescent prior to step G, and a single sample had a pH of around 5.8 (it is expected that this will be between pH 5.5 and pH 6).

In step G the solvent extract (22) is decanted from the bottom of the second container (18) through a particulate filter (muslin cloth or a particulate filter from a domestic garden watering or hose system has been found successful) into one or more third containers (28). The third container (28) is filled until it overflows to ensure minimum ullage (gas/vapour above the liquid level of the third container (28)) then sealed. The third containers (28) used to date are soft drink bottles (PET or PolyEthyleneTerepthalate) which will allow for a certain amount of expansion and contraction of the contents due to temperature. The solvent extract (22) is a clear black liquid which effervesces. As indicated earlier the pH of a single sample of this solvent extract (22) was found to be pH 5.8, and it is expected that it will in general be between pH 5.4 and pH 6, though this is yet to be confirmed.

In step H the solvent extract (22) in the one or more third containers (28) is aged in a cool (below about 30° C.) dry/dark area for a tertiary period (29) to convert the solvent extract (22) to a liquid extract (2). The tertiary period (29) is normally between 1 week and 2 months, and it is storage temperature dependent. The higher the storage temperature the quicker the conversion from solvent extract (22) to liquid extract (2). The solvent extract (22) is properly aged when the contents of the third container (28) has, when all the suspended solids are properly suspended, changed to a reddish brown/golden colour. The pH of the liquid extract in a single sample was found to be pH 3.9 and it is suspected that the effervescence when the third containers (28) are initially filled is due to gas bubbles of carbon dioxide (CO₂). The liquid extract (2) is effervescent, and if a third container (28) containing liquid extract (2) is dropped then opened it behaves like a bottle of soda/soda water.

In step H1 the liquid extract (2) is further processed to form the liquid product (30), this further processing may simply involve resuspending the deposited solids the addition of materials to maintain the suspension of the solids for an extended period or simply transferring the contents to another vessel/container. In some cases, minerals or other supplements may also be added.

In step I the liquid extract (2) is processed to separate out a liquid concentrate, a bug′ concentrate (40), of the active microbiological species. This process and the results are described in a second patent application (NZ 767691 and those claiming priority from it) directed to this concentrate and the active species identified.

### Examples

To interpret the test results a number of definitions will now be introduced, all of these definitions relate to the properties of silage as this is the closest material to the feed supplement (12) that undergoes regular repeatable testing. The feed supplement (12) was tested as if it was a silage with the results given in a table (Table 1).

### Definitions

The normal ranges for silage are given at then end of the definition, note that these may vary slightly depending on the country.
DM % w/w: Dry Matter percentage on a weight for weight basis. In this test the material tested is weighed then dried at 105° C. for 24 hours, and the is dry matter assumed to be the matter remaining at the end of this drying. Normal Range 15 to 40.
CP % w/w DM: Crude Protein content of the dry matter, on a percentage weight for weight basis. For cattle 15% is the minimum to maintain milk production and growth can be achieved with crude protein in the range 10% to 14%. Normal range 10 to 20.
Lipid % w/w DM: Lipid content of the dry matter on a percentage weight for weight basis. High lipid content can interfere with fibre digestion. Normal range 3 to 5.
Ash % w/w DM: Ash content of the dry matter on a percentage weight for weight basis. Normal range 5 to 10.
ADF % w/w DM: Acid Detergent Fibres content of the dry matter on a percentage weight for weight basis. This provides an estimate of the cellulose and lignin content of the silage, this makes up part of the NDF but is an estimate of the indigestible fraction. Normal range 25 to 35.
NDF % w/w DM: Neutral Detergent Fibres content of the dry matter on a percentage weight for weight basis. This provides an estimate of the total cell wall content of the silage. Normal range 35 to 50.
SSS % w/w DM: Soluble Sugars and Starch content of the dry matter as a percentage weight for weight basis. Normal range 0 to 7.
Digestibility % w/w DM: Digestibility estimate of the dry matter on a percentage weight for weight basis. The normal range is 60 to 67, and the following ranges are used to define the quality: Poor <55, Average 55 to 70 and good >70.
ME (est.) MJ/kg DM: Metabolisable Energy in MJ per kg of Dry Matter. This is an estimated measure of the energy available to the animal for maintenance, growth, milk and/or wool production. Normal range 9.5 to 10.5, and the following ranges define the quality: Poor <8, Average 8 to 10, Good 10 to 12, and Excellent >12.
pH: This is the pH of a solution prepared from the silage. Normal range is pH 3.5 to pH 4.5. This range can be up to pH 5 with legume based silage, but a pH above 5 normally indicates poor primary fermentation or subsequent spoilage.
Lactic Acid % w/w DM: This is the Lactic Acid content of the Dry Matter on a percentage weight for weight basis. Lactic acid is important to stabilise the silage and is an indication of the quality of the silage, lower values indicate lower quality. Normal range is 1 to 11 as it covers silages made with a wide range of dry matter levels.
NH4N mg/100 g DM: Total ammoniacal nitrogen in mg per 100 g of dry matter.

In table 1. the results for the various tests is given for the feed supplement (12) which in this case is simply the dry product (10). FS-Sx is the results for Feed Supplement-Sample x (where x=sample number), Normal range is as given above and relative to normal range classifies the range measured as low, normal or high.

TABLE 1

| | | | Normal Range | |
|---|---|---|---|---|
| | | | for | Relative to |
| Test | FS-S1 | FS-S2 | silelage/baleage | normal range |
| DM % w/w: | 25.3 | 63.4 | 15-40 | |
| CP % w/w DM: | 24.4 | 20.7 | 10-20 | High |
| Lipid % w/w | 4.6 | 4.2 | 3-5 | Normal |
| DM: | | | | |
| Ash % w/w DM: | 13.2 | 10.2 | 5-10 | High |
| ADF % w/w | 21.2 | 31.7 | 25-35 | Normal |
| DM: | | | | |
| NDF % w/w | 33.3 | 40.1 | 35-50 | Normal |
| DM: | | | | |
| SSS % w/w | 5.4 | 8.6 | 0-7 | |
| DM: | | | | |
| Digestibility % | >85 | 80.8 | 60-67 | High |
| w/w DM: | | | | |
| ME (est.) MJ/kg | 12.7 | 11.8 | 9.5-10.5 | Very high |
| DM | | | | |
| pH: | 5.8 | 5.7 | 3.5-4.5 | Very high |
| Lactic Acid % | 3.7 | 1.1 | 1-11 | Normal |
| w/w DM: | | | | |

All analysis is carried out by NIRS (Near Infra-Red Spectroscopy) where possible.

Compared to normal silage or baleage the feed supplement (12) in the samples tested have a higher crude protein (CP), much higher digestibility, much higher metabolizable energy and a pH that would be too high for stable silage/baleage, but a lactic acid level in the normal range.

Animal Trial Results:

A number of animal trial results were undertaken, all stock when initially received onto the farm used are chemical drenched to prevent parasite contamination of the farm and this occurred for all trials to date. All stock fed the feed supplement (12) have sought it out and enjoyed eating it. Trial (i) to (iv) are related to the feed supplement (12), trials (v) to (vi) are related to the use of the liquid extract (2). Examples relating to the use of the ‘bug’ concentrate (40) are in a separate New Zealand patent application (NZ 767691) directed to the use of the microbiological species identified, whole of contents included by reference.

Trial (i)

A number of calves were bought, half were given six days of feed supplement (12) which was simply dry product (10). The half fed the supplement developed shiny coats and they became much happier and energetic, even though they were still of a low weight. As the cattle were then fattened those that were fed the supplement on arrival developed longer bodies and thickened more than those that were not fed the supplement at the start.

Trial (ii)

A number of cattle, 15 in total, developed bloat and were fed the feed supplement (12), which was the dry product (10), for a period of time and the majority (all but 1) recovered overnight and the remaining animal received further feed supplement (12) and within 24 hours all affected animals had recovered from bloat. This result was unexpected and to date has only been observed when using the feed supplement (12). This result may be repeated with the liquid extract (2) or ‘bug’ concentrate (40). The use of the feed supplement (12) was simply that the vet was unable to attend quickly and they were doing anything they could to save the cattle.

Trial (iii)

A number of calves in very poor condition (emancipated) were purchased and fed the feed supplement (12), which was essentially the dry product (10), for six days. Though all had dull coats, were thin and lethargic on arrival after six days of the feed supplement (12) all had shiny coats and were energetic, even though still thin. All of the calves went on to be healthy animals.

Trial (iv)

A number of cattle were bought and the group divided into two groups, one received the feed supplement (12), which was essentially the dry product (10). The group fed the feed supplement developed longer bodies and put on about 10% additional mass.

Trial (v)

very light Hereford-Friesian cross yearlings were purchased and provided with one bottle (approx. 1.251) of the liquid extract (2) added to their water trough at approximately weekly intervals. After just over seven months they were sold as healthy shiny cattle.

Trial (vi)

A sheep trial, all exhibiting explosive shitting were drenched using the liquid extract (2) at about the same volumetric dose that cattle would receive a normal chemical drench. Then this was followed with liquid extract (2) dosing of the water trough. The high volume of drench used did not cause any adverse effects and the explosive shitting problem was resolved, and the droppings returned to that normally expected. After this problem was resolved the sheep were taken off the trough dosing and the drenching normally undertaken was done using the liquid extract (2) at normally expected chemical drench levels. It has been found that extending the drench period has been possible using the liquid extract (2) and the flock has remained healthy with no cases of fly strike or the conditions that normally precede fly strike.

Overall Observations:

Used as a drench the liquid extract (2) has replaced chemical drenching that would normally have occurred at least 6 monthly and the results have been the same or better than if chemical drenching had been used. In addition the liquid extract (30) dose volume was approximately 50% of the chemical drench volume.

The cow pats on the paddocks from stock treated with the feed supplement (12) or liquid extract (2) break down and are absorbed by the ground rather than form dry disks.

The feed supplement (12) ameliorating the bloat in cattle was unexpected and surprising, but this has not been repeated with the liquid extract (2) or ‘bug’ concentrate (40) as no naturally occurring cases of bloat have occurred.

Cattle treated with the feed supplement (12) grow frame then put on weight.

Other Test Results:

The liquid extract (2) at about 3 to 4 weeks (fresh) and about six months (old) was tested for lactic acid bacteria activity and yielded the following results:

3 to 4 week old liquid extract (2) CFU/g=400,000,000, pH 3.9;

6 month old liquid extract (2) CFU/g=48,000,000, pH 4.3.

The testing noted that this appeared to be a pure single organism. These results show that although the count is still high in the older sample, the activity, CFU/g, is about 12% of the younger sample and the pH has climbed to pH 4.3. This suggests that it may be possible to provide an indication of the microbial activity of the liquid extract (2) by using the pH, this might be by adding a pH indicator to the liquid extract (2) or testing prior to use (possibly Dichlorofluorescein or possibly bromocresol purple).

The test was an automated MPN (Most Probable Number) count on TEMPO LAB (Lactic Acid Bacteria), incubated at 35° C. for 40-48 hours, with a default detection limit of 10 cfu/g. TEMPO is the registered trade mark of bioMérieux SA (France) (NZ TM No. 793885) and relates to a fully automated enumeration system that provides enumeration of total viable counts, coliform counts, generic E. coli, and Enterobacteriaceae, lactic acid bacteria and Staphylococcus aureus, yeast and molds, and Bacillus cereus in environmental samples tests. The LAB version provides Lactic Acid Bacteria results.

Even though the lactic acid bacteria concentration in the liquid extract (2) was much lower in the 6 month old sample than the fresh sample it is uncertain if this affected the efficacy of the liquid extract (2); this is because a sample of the ‘bug’ concentrate (40) tested at 9 months was found to have essentially no lactic acid bacteria present yet it still appeared to maintain the same, or at least a significant, beneficial efficacy.

Given the ‘bug’ concentrate (40) is, in one form, the separated lactic acid bacteria in a clean growth media, the beneficial effects of the ‘bug’ concentrate (40), with no residual lactic acid bacteria activity, appears to be due (at least in part) to metabolites and/or other chemical species generated by the microbial population initially present. These metabolites and/or other chemical species may act alone or in combination with the lactic acid bacteria present to cause the beneficial effects observed.

Given there is at least some beneficial activity of the ‘bug’ concentrate (40) that persists after the lactic acid bacteria ceases to be active it appears reasonable to assume this also occurs in the liquid extract (2) and/or liquid product (30).

It is possible that the metabolites and/or other chemical species will be identified and maintain their activity in a dried or concentrated form created from the liquid extract (2), liquid product (30) or ‘bug’ concentrate (40). These dried or concentrated forms could be created by known means that include reverse osmosis, precipitation, spray drying, vacuum drying, thermal drying, crystallisation, evaporation (vacuum or thermal), cooling/freezing, solvent extraction (including stationary solid phase), formation of insoluble species, electrophoresis, or a combination of two or more of these sequentially or simultaneously.

### KEY

1. Feed supplement;
2. Liquid extract;
3. Grass;
7. Dry grass;
8. First container;
9. Primary period;
10. Dry product;
12. Feed supplement;
18. Second container;
19. Liquid solvent;
21. Secondary period;
22. Solvent extract;
28. Third container;
29. Tertiary period;
30. Liquid product;
40. ‘bug’ concentrate;

1. A method of making a product from grass that includes carrying out steps A to D in order, where:
Step A is cutting the grass to a length of between 35 mm to 150 mm resulting in cut grass with at least 90% leaf and little to no dead plant material;
Step B is drying of the cut grass to produce dry grass;
Step C is collecting and transferring the dry grass to at least one first container, removing excess air and then sealing the at least one first container; and
Step D is aging the dry grass in the at least one first containers in a cool dark place for a primary period of time to produce a dry product.

2. The method as claimed in claim 1, wherein the leaf content of the cut grass is no less than 95%.

3. The method as claimed in claim 1, wherein there is no observable dead plant material present in the cut grass.

4. The method as claimed in claim 1, wherein the drying in step B is carried out until the cut grass, when squeezed in a hand leaves the hand dry with the grass leaf not crumbling or breaking.

5. (canceled)

6. The method as claimed in claim 1, wherein the primary period in step D up to 6 months.

7. (canceled)

8. The method as claimed in claim 1, wherein primary period in step D is between 3 and 4 weeks.

9. The method as claimed in claim 1, wherein the temperature in step D does not exceed 35° C.

10.-12. (canceled)

13. The method as claimed in claim 1, wherein the dry product is further processed to create a feed supplement.

14. The method as claimed in claim 1, wherein a liquid extract is made from the dry product by carrying out steps E to H in order, where steps E to H are:
Step E is transferring a portion of dry product to a second container and adding a liquid solvent until the dry product is covered;
Step F is steeping the dry product in the liquid solvent for a secondary period to create a solvent extract;
Step G is transferring the solvent extract to at least one third container whilst filtering the solvent extract to remove particulate material then sealing the at least one third container ensuring minimal ullage;
Step H is aging the solvent extract in the at least one sealed third container for a tertiary period to form a liquid extract.

15. (canceled)

16. The method as claimed in claim 14, wherein the liquid solvent is water or an aqueous solvent.

17.-19. (canceled)

20. The method as claimed in claim 14, wherein the secondary period is between 4 and 12 hours.

21.-22. (canceled)

23. The method as claimed in claim 14, wherein the tertiary period is less than 6 months.

24.-26. (canceled)

27. The method as claimed in claim 14, wherein the tertiary period is determined by a storage temperature, where the storage temperature is the temperature at which the solvent extract is stored, wherein the tertiary period increases as the storage temperature decreases.

28. (canceled)

29. The method as claimed in claim 14, wherein the tertiary period is at least 3 weeks and the liquid extract has a pH of less than pH 6.

30. (canceled)

31. The method as claimed in claim 29, wherein the liquid extract has a pH of no more than 4.5.

32. The method as claimed in claim 29, wherein the liquid extract has a pH of no more than 4.3.

33. The method as claimed in claim 14, wherein the solvent extract starts as a clear black liquid and this changes to the liquid extract which is a reddish brown liquid, and the tertiary period is determined by this change.

34. The method as claimed in claim 33, wherein the tertiary period is the time it takes for this colour change to occur.

35. The method as claimed in claim 14, wherein minimal ullage means that any void above a liquid level of the solvent extract in the at least one third container is no more than 5% the height of the third container.

36.-41. (canceled)

42. The method as claimed in claim 14, wherein a metabolite and/or chemical species is extracted from the liquid extract or any product created from the liquid extract.

43. The method as claimed in claim 42, wherein the metabolite and/or chemical species extracted is in a dried or concentrated form.

44. (canceled)

45. The method as claimed in claim 43, wherein the dried or concentrated form of the metabolite and/or chemical species extract is created by one or more processes selected from the list consisting of reverse osmosis, precipitation, spray drying, vacuum drying, thermal drying, crystallisation, evaporation (vacuum or thermal), cooling/freezing, solvent extraction (including stationary solid phase), formation of insoluble species, and electrophoresis, or a combination of two or more of these processes sequentially or simultaneously.

46. (canceled)

47. The method as claimed in claim 1, wherein the dry product has a pH between 5.4 and 6.
